(19) United States
(12) Patent Application Publication
(10) Pub. No.: US 2025/0048224 A1
(43) Pub. Date: Feb. 6, 2025

(54) MITIGATING HANDOVER CONGESTION IN A NETWORK

(71) Applicant: Nokia Technologies Oy, Espoo (FI)

(72) Inventors: Jeroen WIGARD, Klarup (DK); Enric JUAN, Aalborg (DK); Jedrzej STANCZAK, Wroclaw (PL)

(21) Appl. No.: 18/790,660

(22) Filed: Jul. 31, 2024

(30) Foreign Application Priority Data
Aug. 4, 2023 (FI) 20235868

(51) Int. Cl. H04W 36/36; H04L 43/0852

(52) U.S. Cl. CPC H04W 36/362; H04L 43/0852

(57) ABSTRACT

Aspects and embodiments relate to apparatus configured to delay execution of an action based on an execution delay and methods to delay execution of an action. In particular, the example embodiments provide apparatus and methods to delay execution of mobility related events, for example, handover. One aspect provides an apparatus, comprising: at least one processor; and at least one memory storing instructions that when executed by the at least one processor cause the apparatus at least to: obtain an indication of an execution delay to be applied by the apparatus in relation to an action to be executed by the apparatus, the execution delay being based upon one or more operational characteristic of the apparatus; determine that the action is to be executed by the apparatus; and delay execution of the action based on the execution delay. Arrangements and implementations provide a mechanism to mitigate RACH load congestion. Arrangements provide mechanisms to distribute a handover execution load (in the form, for example, of RACH attempts initiated by UE) across a restricted or limited time period.

### TECHNOLOGICAL FIELD

Various example embodiments relate to apparatus configured to delay execution of an action based on an execution delay and methods to delay execution of an action. In particular, the example embodiments provide apparatus and methods to delay execution of mobility related events, for example, handover.

### BACKGROUND

3GPP standards include support for use of non-terrestrial network (NTN) nodes, including Low-Earth Orbit (LEO), GEO satellites, unmanned aerial system (UAS), High Altitude Platform System (HAPS) devices, and similar, to provide, for example, 5G New Radio (NR) services to users on Earth. In other words, the 5G NR standard recognises that non-terrestrial devices, including devices located on planes, or other flying objects located above the Earth can form part of a radio access network, provide coverage, and support communication within that radio access network.

The 5G NR standard recognises that an NTN may be used to support communication within a wireless communication network with devices of various types, including: personal user devices, and Narrow Band-Internet of Things (NB-IoT) devices and enhanced Machine Type Communication (eMTC) devices, all of which fall under the umbrella term “User Equipment” (UE).

Various challenges arise as a result of use of NTN devices as RAN nodes in wireless communication systems, including some challenges in relation to support of mobility in a network including NTN functionality.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments there is provided an apparatus, comprising: at least one processor; and at least one memory storing instructions that when executed by the at least one processor cause the apparatus at least to: obtain an indication of an execution delay to be applied by the apparatus in relation to an action to be executed by the apparatus, the execution delay being based upon one or more operational characteristic of the apparatus; determine that the action is to be executed by the apparatus; and delay execution of the action based on the execution delay.

According to some embodiments, the execution of the action is delayed until the execution delay has passed.

According to some embodiments, the action to be executed by the apparatus comprises: a transmission of a random access channel preamble.

According to some embodiments, the action to be executed by the apparatus is associated with a mobility event, the action comprising: a handover or a conditional handover.

According to some embodiments, the action to be executed by the apparatus is associated with: apparatus reconfiguration based on an obtained Radio Resource Control reconfiguration message and optionally where the reconfiguration message comprises a handover or conditional handover command.

According to some embodiments, the action to be executed by the apparatus is associated with: a mobility event according to which the apparatus is configured to obtain a resource grant by monitoring a received signal.

According to some embodiments, the mobility event is associated with: a Random Access Channel free mobility event and the apparatus is configured to obtain an uplink grant by monitoring a physical downlink control channel.

According to some embodiments, the mobility event is associated with: a Random Access Channel free mobility event and the apparatus has obtained a preconfigured resource grant of time or frequency resource.

According to some embodiments, the apparatus is caused to: obtain an indication of a time restriction for performing the action to be executed by the apparatus, wherein the execution delay to be applied by the apparatus is further based on the obtained indication of time restriction.

According to some embodiments, the apparatus may be caused to evaluate the time restriction based upon the obtained indication.

According to some embodiments, the time restriction comprises: an indication of a final time by which the action must be completed.

According to some embodiments, the time restriction comprises: an indication of a final time by which the action must be initiated by the apparatus.

According to some embodiments, the operational characteristic of the apparatus is based on likelihood of success of the action to be executed by the apparatus, and the greater the likelihood of success, the longer the resulting execution delay.

According to some embodiments, the operational characteristic of the apparatus is based on likelihood of success of the action to be executed by the apparatus, and the greater the likelihood of success, the smaller the resulting execution delay.

According to some embodiments, the likelihood of success of the action to be executed by the apparatus is based on at least one of the following: radio condition being experienced by the apparatus, an indication of a number of other apparatuses expected to perform the action to be executed by the apparatus, an indication of historic success rate of the action to be executed by the apparatus, or an indication of current success rate of the action to be executed by the apparatus.

According to some embodiments, the indication is received in messaging from a network by the apparatus.

According to some embodiments, the messaging from the network comprises broadcast or apparatus specific messaging from the network.

According to some embodiments, the operational characteristic of the apparatus is based on priority of the apparatus, and the greater the priority of the apparatus, the smaller the resulting execution delay.

According to some embodiments, the priority of the apparatus is based on at least one of the following: an indication of quality of service associated with the apparatus, an indication of apparatus priority provided to the apparatus, or an indication of a time remaining before the action to be executed by the apparatus must be initiated or completed.

According to some embodiments, the execution delay is further based upon a feature of a unique identifier associated with the apparatus.

According to some embodiments, the feature of the unique identifier comprises: at least one digit of the unique identifier.

According to some embodiments, the execution delay comprises a function of one or more operational characteristic associated with the apparatus.

According to some embodiments, the action to be executed by the apparatus is associated with a mobility event comprising: handover or conditional handover.

According to some embodiments, the action to be executed by the apparatus comprises conditional handover between a source cell and a target cell in a Non-Terrestrial Network.

According to some embodiments, wherein the action to be executed by the apparatus is triggered by one or more action trigger condition to be evaluated by the apparatus.

According to some embodiments, the apparatus is caused to: determine that the action is to be executed by the apparatus by determining that the one or more action trigger condition is evaluated to be met.

According to some embodiments, the apparatus comprises user equipment comprising circuitry configured to generate radio frequency signals.

According to various, but not necessarily all, example embodiments there is provided.

an apparatus, comprising: means to obtain an indication of an execution delay to be applied by the apparatus in relation to an action to be executed by the apparatus, the execution delay being based upon one or more operational characteristic of the apparatus; means to determine that the action is to be executed by the apparatus; and means to delay execution of the action based on the execution delay.

The means may perform the optional features set out in relation to the apparatus mentioned above.

According to various, but not necessarily all, example embodiments there is provided an apparatus comprising: circuitry configured to obtain an indication of an execution delay to be applied by the apparatus in relation to an action to be executed by the apparatus, the execution delay being based upon one or more operational characteristic of the apparatus; circuitry configured to determine that the action is to be executed by the apparatus; and circuitry configured to delay execution of the action based on the execution delay.

The circuitry may be configured perform the optional features set out in relation to the apparatus mentioned above.

According to various, but not necessarily all, example embodiments there is provided a method, comprising: obtaining an indication of an execution delay to be applied by an apparatus in relation to an action to be executed by the apparatus, the execution delay being based upon one or more operational characteristic of the apparatus; determining that the action is to be executed by the apparatus; and delaying execution of the action until the execution delay has passed.

According to some embodiments, the execution of the action is delayed until the execution delay has passed.

According to some embodiments, the action to be executed by the apparatus comprises: a transmission of a random access channel preamble.

According to some embodiments, the action to be executed by the apparatus is associated with a mobility event, the action comprising: a handover or a conditional handover.

According to some embodiments, the action to be executed by the apparatus is associated with: apparatus reconfiguration based on an obtained Radio Resource Control reconfiguration message and optionally where the reconfiguration message comprises a handover or conditional handover command.

According to some embodiments, the action to be executed by the apparatus is associated with: a mobility event according to which the apparatus is configured to obtain a resource grant by monitoring a received signal.

According to some embodiments, the mobility event is associated with: a Random Access Channel free mobility event and the apparatus is configured to obtain an uplink grant by monitoring a physical downlink control channel.

According to some embodiments, the mobility event is associated with: a Random Access Channel free mobility event and the apparatus has obtained a preconfigured resource grant of time or frequency resource.

According to some embodiments, the method comprises: obtaining an indication of a time restriction for performing the action to be executed by the apparatus, wherein the execution delay to be applied by the apparatus is further based on the obtained indication of time restriction.

According to some embodiments, the time restriction comprises: an indication of a final time by which the action must be completed.

According to some embodiments, the time restriction comprises: an indication of a final time by which the action must be initiated by the apparatus.

According to some embodiments, the operational characteristic of the apparatus is based on likelihood of success of the action to be executed by the apparatus, and the greater the likelihood of success, the longer the resulting execution delay.

According to some embodiments, the operational characteristic of the apparatus is based on likelihood of success of the action to be executed by the apparatus, and the greater the likelihood of success, the smaller the resulting execution delay.

According to some embodiments, the likelihood of success of the action to be executed by the apparatus is based on at least one of the following: radio condition being experienced by the apparatus, an indication of a number of other apparatuses expected to perform the action to be executed by the apparatus, an indication of historic success rate of the action to be executed by the apparatus, or an indication of current success rate of the action to be executed by the apparatus.

According to some embodiments, the indication is received in messaging from a network by the apparatus.

According to some embodiments, the operational characteristic of the apparatus is based on priority of the apparatus, and the greater the priority of the apparatus, the smaller the resulting execution delay.

According to some embodiments, the priority of the apparatus is based on at least one of the following: an indication of quality of service associated with the apparatus, an indication of apparatus priority provided to the apparatus, or an indication of a time remaining before the action to be executed by the apparatus must be initiated or completed.

According to some embodiments, the execution delay is further based upon a feature of a unique identifier associated with the apparatus.

According to some embodiments, the feature of the unique identifier comprises: at least one digit of the unique identifier.

According to some embodiments, the execution delay comprises a function of one or more operational characteristic associated with the apparatus.

According to some embodiments, the action to be executed is associated with a mobility event comprising: handover or conditional handover.

According to some embodiments, the action to be executed comprises conditional handover between a source cell and a target cell in a Non-Terrestrial Network.

According to some embodiments, the action to be executed by the apparatus is triggered by one or more action trigger condition to be evaluated by the apparatus.

According to some embodiments, the method comprises: determining that the action is to be executed by the apparatus by determining that the one or more action trigger condition is evaluated to be met.

According to some embodiments, the method is performed by user equipment comprising circuitry configured to generate radio frequency signals.

According to various, but not necessarily all, example embodiments there is provided a non-transitory computer readable medium comprising program instructions stored thereon for performing at least the following: obtaining an indication of a execution delay to be applied by an apparatus in relation to an action to be executed by the apparatus, the execution delay being based upon one or more operational characteristic of the apparatus; determining that the action is to be executed by the apparatus; and delaying execution of the action until the execution delay has passed.

The instructions may be for performing the optional features set out in relation to the method mentioned above.

According to various, but not necessarily all, example embodiments there is provided a computer program product operable, when executed on a computer, to obtain an indication of an execution delay to be applied by an apparatus in relation to an action to be executed by the apparatus, the execution delay being based upon one or more operational characteristic of the apparatus; determine that the action is to be executed by the apparatus; and delay execution of the action until the execution delay has passed.

The computer program product may be operable to perform the optional features set out in relation to the method mentioned above.

According to various, but not necessarily all, example embodiments there is provided an apparatus, comprising: at least one processor; and at least one memory storing instructions that when executed by the at least one processor cause the apparatus at least to: determine an action to be executed by a user equipment; provide an indication of an execution delay to be applied by the user equipment in relation to the action, the execution delay being based upon one or more operational characteristic of the user equipment.

The apparatus may comprise a base station comprising circuitry configured to generate radio frequency signals.

The base station apparatus may be configured perform analogous optional features set out in relation to the user equipment apparatus mentioned above.

According to various, but not necessarily all, example embodiments there is provided an apparatus, comprising: circuitry configured to determine an action to be executed by a user equipment; circuitry configured to provide an indication of an execution delay to be applied by the user equipment in relation to the action, the execution delay being based upon one or more operational characteristic of the user equipment.

According to various, but not necessarily all, example embodiments there is provided an apparatus, comprising: means configured to determine an action to be executed by a user equipment; means configured to provide an indication of an execution delay to be applied by the user equipment in relation to the action, the execution delay being based upon one or more operational characteristic of the user equipment.

According to various, but not necessarily all, example embodiments there is provided a method comprising: determining an action to be executed by user equipment; providing an indication of an execution delay to be applied by the user equipment in relation to the action, the execution delay being based upon one or more operational characteristic of the user equipment.

The method performed by a base station may be configured perform analogous optional features set out in relation to the user equipment method mentioned above.

According to various, but not necessarily all, example embodiments there is provided a non-transitory computer readable medium comprising program instructions stored thereon for performing at least the following: determining an action to be executed by user equipment; providing an indication of an execution delay to be applied by the user equipment in relation to the action, the execution delay being based upon one or more operational characteristic of the user equipment.

According to various, but not necessarily all, example embodiments there is provided a computer program product operable, when executed on a computer, to determine an action to be executed by user equipment; and provide an indication of an execution delay to be applied by the user equipment in relation to the action, the execution delay being based upon one or more operational characteristic of the user equipment.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

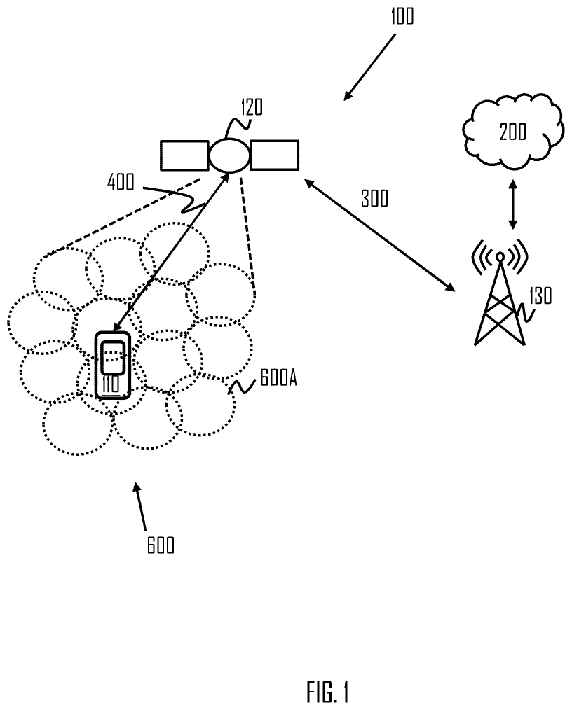

FIG. 1 illustrates schematically some main components of a typical Non-Terrestrial Network;

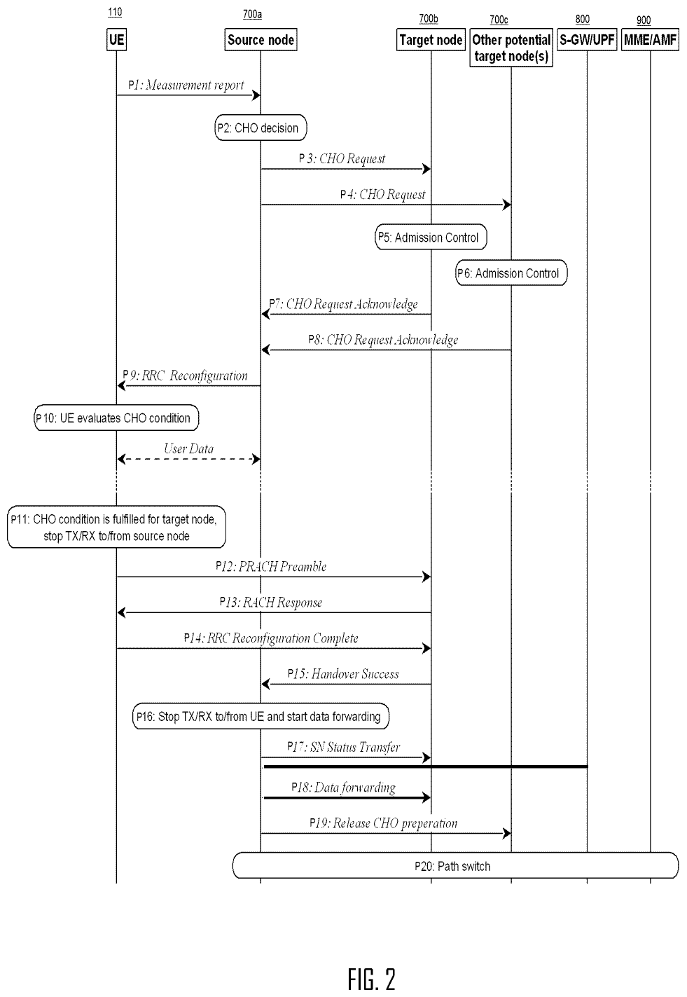

FIG. 2 illustrates schematically a basic Conditional Handover scheme;

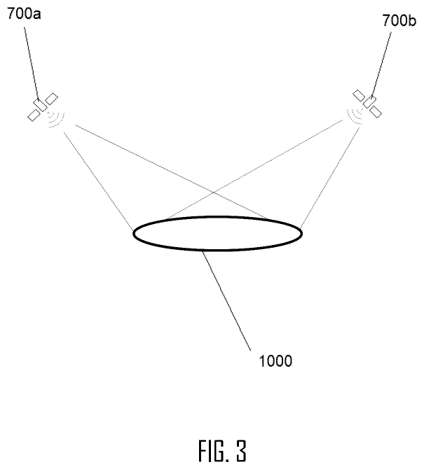

FIG. 3 illustrates schematically cell overlap of a source cell and target cell in an Earth Fixed Cell network deployment;

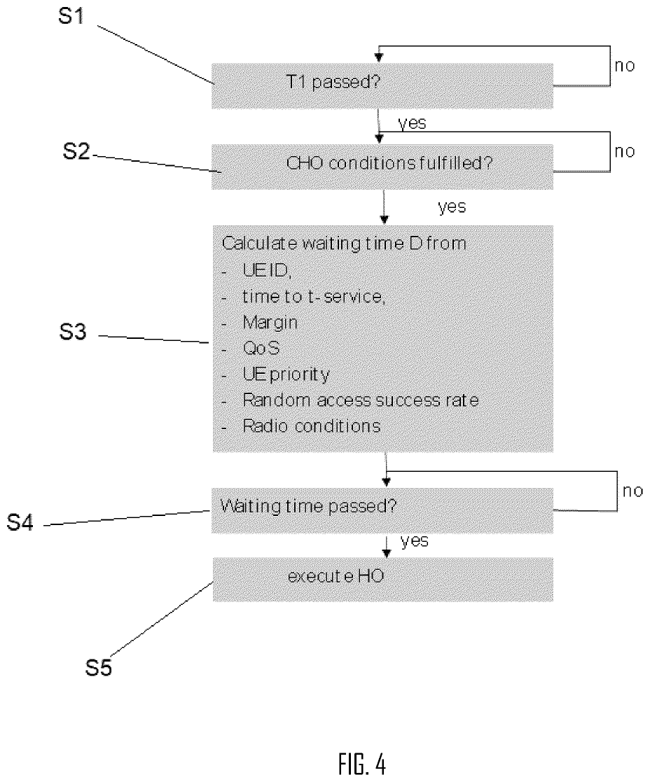

FIG. 4 illustrates schematically steps implementable at user equipment according to one implementation;

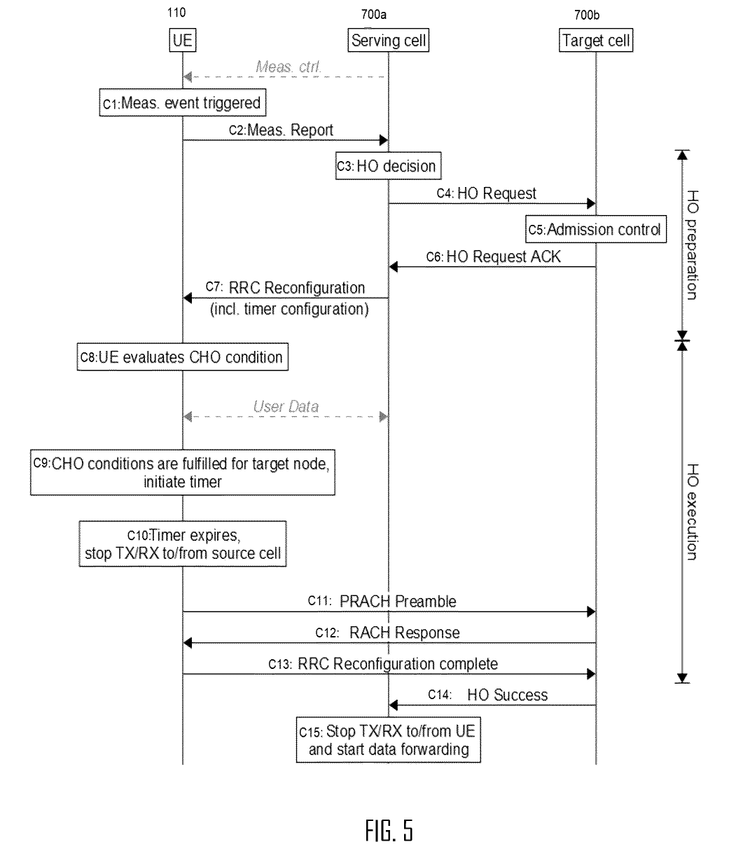

FIG. 5 is a signalling diagram illustrating schematically a Conditional Handover scheme which includes a general implementation of a HO execution timer in accordance with arrangements;

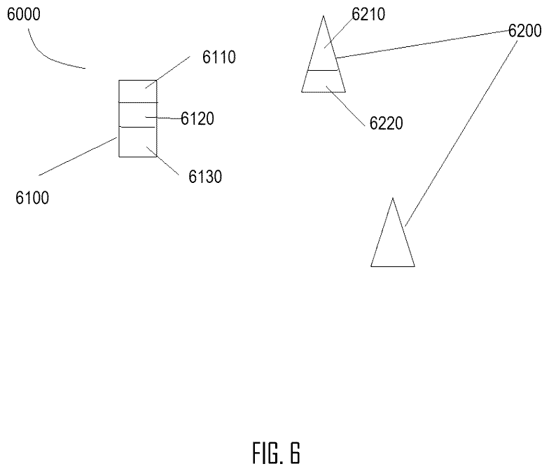

FIG. 6 illustrates schematically some components of a wireless communication network including nodes according to some arrangements; and

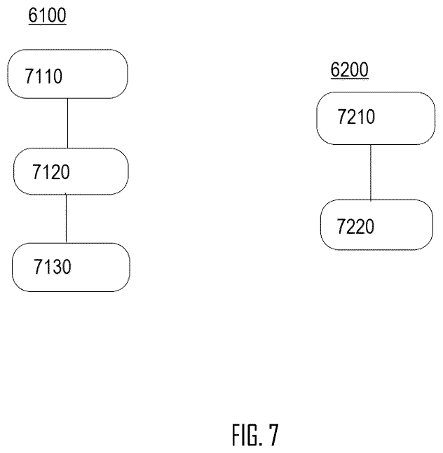

FIG. 7 illustrates schematically steps of methods performed at nodes in accordance with some arrangements.

### DETAILED DESCRIPTION

Before discussing the example embodiments in any more detail, first an overview will be provided.

NTN have been specified as a part of Release 17 of the 3GPP standards. The main deployment scenario envisaged uses low-earth orbit (LEO) satellites at altitudes of 600 km to 1200 km in a transparent architecture to facilitate communication between user equipment (UE) and a base station on Earth. Release 18 further enhances NTN by setting out improvements in various operational areas, including support for UE mobility.

### Non-Terrestrial Networks (NTN)

FIG. 1 illustrates schematically some main components of a typical Non-Terrestrial Network 100. In non-terrestrial network 100 communication service is provided to user equipment (UE) 110 via one or more satellites or Unmanned Aircraft System (UAS) platforms 120. User data from a data network 200 is routed through an NTN gateway 130, located on the ground, and the satellite or UAS platform 120. Typically a wireless link between a satellite or UAS platform 120 and the NTN gateway 130 (NTN-GW) is referred to as a “feeder link” 300, and a wireless link 400 between a satellite and each UE is referred to as a “service link”.

The satellite or UAS platform 120 may comprise a Low Earth Orbit (LEO) satellite which orbits the Earth at altitudes of between 500-1500 km. Each such LEO satellite may typically provide an NR service region 600 on Earth via one or more satellite beams which create NR cells in their beam footprint 600a. Due to their low altitude, such LEO satellites move relative to the Earth's surface with a speed about 7.5 km/s, and the NR service region 600 can be considered to be constantly scanning across a region of the surface of the Earth.

UE 110 operating in an NTN such as that shown, will have Global Navigation Satellite System (GNSS) support, meaning that the UE 110 will typically have access to what would normally be considered GNSS location and/or GNSS time. Provision of support for GNSS is that the UE needs to obtain an understanding of the time and frequency relationship between itself and any satellite forming part of the NTN Radio Access Network (RAN) in order to synchronize and remain synchronised.

Arrangements described relate generally to approaches applicable to support Conditional Handover (CHO) in relation to Non-Terrestrial Networks (NTN). More specifically, arrangements described relate to approaches applicable to support CHO for Earth Fixed Cells.

### Earth Fixed Cells (EFC)

Earth Fixed Cells are cells of radio coverage which are projected onto Earth via satellite beams which are adjusted such that the cell does not move with the movement of the satellite. In other words, the satellite or UAS platform is configured such that it continuously adjusts a direction of a beam to compensate for the movement of the satellite relative to the Earth (7.5 km/s).

Even with such continuous beam adjustment, at some point a satellite providing an EFC may be located relative to the EFC such that it is unable to effectively serve that EFC, or other deployment or configuration aspects may be such that the satellite may stop serving an area. In such cases, a new satellite may be configured to provide a beam of radio coverage that effectively “takes over” that EFC and serves that EFC area. In such a scenario, UE in the EFC may need to make a handover to the new cell. It is likely, in the event of such a switch, that a large number of the UE in the EFC will need to perform a handover to the “new” beam serving the EFC. That handover of multiple UE is likely to need to occur within a limited time period, which can create an expected peak in handover related messaging and processing.

Conditional Handover (CHO) has been defined as a part of 3GPP Release-16. An aim of CHO is that of increasing handover robustness by decoupling HO preparation and HO execution phases.

CHO is a mechanism which may aid effective handover of UE operating in an EFC. CHO is recognised in Release 17 of the 3GPP standard as being helpful to support NTN operation, and some NTN-specific enhancements are provided.

FIG. 2 illustrates schematically a basic Conditional Handover scheme. In particular, FIG. 2 is a signalling diagram indicating signalling steps which occur between various nodes in a standard network as part of a Conditional Handover scheme. Those nodes include: user equipment 110; a source node 700a; a target node 700b; other potential target nodes 700c; a serving gateway, user plane function or equivalent 800; and a mobility management entity or access and mobility management function entity or equivalent 900.

FIG. 2 shows a CHO scheme in which Steps P1 to P9 are similar to a Baseline HO (BHO) set in New Radio (NR) Release 15 of 3GPP standardization.

At step P1: A configured event triggers the UE 110 to send a measurement report.

At step P2: Based on the UE measurement report, the source node 100a is configured to take CHO action.

At step P3 and P4: the source node communicates with one or more target nodes 700b, 700c, to prepare one or more target cells for the handover by sending a CHO Request.

At steps P5 and P6: the target nodes 700b and 700c perform admission control in relation to the CHO request from the source node 700a.

At steps P7 and P8: assuming the admission control at potential target nodes 700b and 700c are successful, the potential target nodes 700b and 700c inform the source node 700a that the CHO request has been acknowledged.

At step P9: the source node is configured to sends an RRC Reconfiguration (handover command) to the UE 110.

In relation to basic handover (BHO) as set out in NR Rel. 15, the UE 110 would immediately access the target cell to complete the handover. In relation to conditional handover (CHO), the UE 110 is configured such that it will only take steps to access a target cell once an additional CHO execution condition is fulfilled. In other words, the HO preparation and execution phases are decoupled. The additional CHO condition is typically configured, for example, by the source node 700a to the UE as part of a HO Command. An advantage of CHO is that a HO command can be sent in advance of a likely required HO event, for example, while a radio link between a source cell, supported by a source node 700a, and a UE is strong enough, without risking a UE attempting access to a network via a target cell and potentially causing issues in relation to a UE to network connection using either the source or target cell. That is to say, the CHO procedure can provide mobility robustness within a network.

In standard HO schemes such as those described above, the handover and conditional handover measurement trigger conditions are typically linked to radio condition experienced and measured at the UE. For example, the trigger condition may comprise a threshold Reference Signal Received Power (RSRP) difference at the UE between the source cell and target cell.

In Release 17 NTN, the CHO scheme has been enhanced such that it is linked, as before, to the (radio) condition experienced at the UE (such as measurement events A3, A4 or A5 (defined in RRC) but also to a time condition requiring that a trigger measurement event occurs within a time window (for example, measurement event A3, A4, A5 fulfilled within the time window [t1, t2]). In other words, in relation to NTN CHO it is possible to provide a joint configuration relating to location and RSRP as well as time and RSRP. Such conditions recognise that the received power level alone may not be sufficient in an NTN for a UE to make a decision regarding whether it is appropriate to trigger a mobility event. This may particularly occur because in an NTN EFC the RSRP at the cell edge (which is typically the region relevant for handover) may not be largely different to the RSRP measured at the cell center.

FIG. 2 also includes signalling steps of relevance in a CHO procedure.

At step P10: the UE 110 is configured to evaluate a CHO condition set in the RRC reconfiguration of step P9.

At step P11: in the case of a CHO event in an NTN, the NTN UE 110 may have a CHO condition which may include a location/time and radio measurement condition(s).

The time-based CHO execution condition is specified in technical standards of 3GPP as “CondEvent T1”.

Technical standards of 3GPP set out that:

CondEvent T1 (Time Measured at UE is within a Duration from Threshold)

The UE shall:
1> consider the entering condition for this event to be satisfied when condition T1-1, as specified below, is fulfilled;
1> consider the leaving condition for this event to be satisfied when condition T1-2, as specified below, is fulfilled;

### Inequality T1-1 (Entering Condition)

Mt>Thresh1

### Inequality T1-2 (Leaving Condition)

$$Mt > Thresh 1 + Duration$$

The variables in the formula are defined as follows:
Mt is the time measured at UE.
Thresh1 is the threshold parameter for this event (i.e. t1-Threshold as defined within reportConfigNR for this event).
Duration is the duration parameter for this event (i.e. duration as defined within reportConfigNR for this event).
Mt is expressed in ms.
Thresh1 is expressed in the same unit as Mt.
Duration is expressed in the same unit as Mt.

Typical use of the time-based CHO with [t1, t2] condition is in relation to an NTN EFC. In EFC it is assumed that there is an overlap in time where both source and target cell are available at the same area on Earth: they create the same cell area. Typically, the value of t1 and t2 will be set to the start and end of the time overlap window, i.e., t1 is set to the time where a target cell becomes available and t2 at the time where the source cell “disappears”. However, a time window may be set such that there is a short overlap for handover within a total time overlap window, or may be set such that there is no overlap. Furthermore, t2 may be set such that it is greater than t-service. In general terms, t1 and t2 may not necessarily relate to an overlap in coverage between a source and target cell. t1 and t2 may, for example, relate to a timing in coverage relating to a target cell only. Accordingly, a time window can be set individually for each handover or conditional handover candidate cell.

FIG. 3 illustrates schematically cell overlap of a source cell and target cell in an Earth Fixed Cell network deployment. As shown in FIG. 3, a source cell of the Earth Fixed Cell 1000 is provided by satellite 700a and a target cell of the Earth Fixed Cell 1000 is provided by satellite 700b.

A UE may be configured, if applying the enhanced CHO condition, to check radio conditions experienced at the UE from the source and target cell in the time window between t1 and t2 and, if the handover condition relating to radio condition is met within that time window, to perform a handover. It will be appreciated that during the time t1-t2 both cells are available at the same cell area, and these cells will interfere with each other if they are using the same frequency, so some interference coordination may be needed, but addressing that issue is outside the scope of CHO consideration in the context of described arrangements.

Provided a CHO condition is determined to be met at the UE, FIG. 2 sets out the further steps which occur to enable successful handover.

At step P12: Having determined that the CHO condition is met, the UE 110 is configured to transmit a Physical Random Access Channel (PRACH) preamble (both in the case of Contention Free Random Access and Contention Based Random Access) to the target node 700b for which the CHO condition was determined to be met.

At step P13: the target node 700b is configured to respond to the UE PRACH preamble with a PRACH response.

At step P14: the UE is configured to confirm to the target node 700b that the RRC reconfiguration required at the UE has been completed.

At step P15: the target node 700b is configured to inform the source node 700a that Handover has successfully been completed.

At step P16: the source node 700a is configured, after receipt of the handover success messaging from target node 700b, to stop transmission to, and reception from, the UE 110 and begin data forwarding in order to ensure no packets are lost as part of the handover.

At step P17: the serving node status is transferred to the target node 700b.

At step P18: the previous source node 700a continues data forwarding to the new source node 700b.

At step P19: the original source node 700a releases the CNO preparation which was done at other potential target bodes 700c.

At step P20: All network side entities (700a, 700b, 700c, 800 and 900) perform a path switch, such that UE 110 is attached to new source node 700b.

Implementation of CHO in relation to an NTN EFC is likely to result in a large number of UEs performing handover at almost the same time. Handover congestion is therefore likely to occur in the network. To mitigate such congestion, in particular on the PRACH requests sent by the UE to the target node, one possibility is to randomly scatter the RACH initiation time at the UE to distribute the handover load. Arrangements described recognise that simple random scattering of RACH initiation time may still result in significant handover congestion.

Arrangements described seek to address generally cases where a large number of UE may be triggered to execute an action at substantially the same time, resulting in significant collision inefficiency within the network. Arrangements described seek to, for example, mitigate handover congestion, by taking steps to more intelligently distribute handover initiation by a large number of UE within a limited time period. In particular, some implementations provide a network configured mechanism for distributing an action, for example, a number of UE handovers, across a restricted time window. Arrangements and implementations described in more detail below seek to spread an anticipatable peak in signalling or messaging load within a network.

The specification of condEvent T1 does not include provision for prevention of a large number of UEs being configured with the same T1-T2 and, therefore, it allows that a time-based CHO execution condition can be fulfilled for a large number of UEs substantially simultaneously. If, for example, a large number of UEs in a serving cell initiate random access at almost at the same time, it is likely that such a large number of requests will result in a poor random access success rate, in other words, RACH load congestion.

Arrangements and implementations provide a mechanism to mitigate RACH load congestion. Arrangements provide mechanisms to distribute a handover execution load (in the form, for example, of RACH attempts initiated by UE) across a restricted or limited time period. In the case of Handover in an EFC for example, that time period may comprise the period between a target cell becoming available and a source cell becoming unavailable (T1-T2) or the period between the time that the target cell is available and t-Service (when a serving cell is no longer available). Distribution of handover execution may be achieved, in some implementations, via network control of UE handover execution requests across a known time period.

Approaches which rely upon a completely random selection of delay are suboptimal. For example, random distribution may still result in a load which is high and can lead to handover failures. Randomness also may not ensure even distribution in time. Approaches in accordance with described arrangements recognize that it may be beneficial to allow some network control, supporting a distribution in which appropriate UEs have a higher likelihood of success. For instance, by allocating high priority UE a short execution delay, they may be able to attempt connection twice in a limited window, assuming the first attempt is unsuccessful. Similarly, approaches in accordance with described arrangements may prioritize user equipment determined to be operating in good radio conditions.

Approaches relying solely upon a random distribution are deprived of the possibility to apply a degree of intelligent UE-specific shift. Whilst a unique shift for each UE calculated by the network would involve a large signalling overhead, approaches recognize that implementing a delay which corresponds to one or more of the operational characteristics of the UE (for example, the type or priority of services being supported and similar) can provide a distribution of action across a time window. In some arrangements, a distribution of delay based upon an operational characteristic of a UE may be further distributed by use of another parameter, for example, another operational characteristic, or other characteristic of UE, for example UEID.

FIG. 4 illustrates schematically steps implementable at user equipment according to one implementation.

According to the implementation shown schematically in FIG. 4, as part of a received RRC Reconfiguration message, a UE may receive a configuration including CHO execution conditions and a HO execution timer configuration or one or more HO execution timer setting. HO execution timer configuration or setting may comprise a network-controlled UE-assisted “timer” which has a configurable duration. The duration may be configured to depend upon one or more parameters. The one or more parameters may comprise one or more operational characteristic of, or associated with, the user equipment. Examples of such parameters include, for example, remaining time until t-service, required UE Quality of Service (QOS), UE priority, one or more radio condition measurement, load of target cell, number of expected UEs to handover based on number of UEs in serving cell, historic of random access success rate, current random access success rate, and similar.

According to one implementation, until CHO is triggered, a UE may be operable to perform as set out in relation to the general scheme shown in FIG. 2. According to arrangements in which a HO execution timer is implemented, when the UE fulfills the CHO requirements (for example, T1, T2, and other radio condition trigger(s)) rather than immediately performing handover, standard transmission and reception operation at the UE to and from the source cell continue.

As shown in FIG. 4, a UE may be configured to perform steps of:
S1: The UE may be configured to monitor a time-based parameter relating to CHO
S2: If the time-based parameter is fulfilled, the UE may then evaluate whether CHO conditions, for example, those relating to radio condition, are fulfilled

According to described arrangements, when CHO conditions are met, instead of performing the HO immediately, the UE is configured to implement an execution delay. The execution delay in this described implementation may be indicated to the UE via a HO execution timer configuration or setting received from the network. In this implementation, when the UE determines that the condition(s) to execute handover are met, the UE start the UE-assisted “timer” which has a configurable duration. The timer is used by the UE to ensure the delay occurs before the handover is executed.
S3: The UE evaluates, based on the HO execution timer condition(s) set by the network or as preconfigured to the UE, a wait duration and starts a timer. Effectively, implementations are such that each UE waits a certain UE-specific time before initiating a HO. At step S3, the UE is still configured such that transmission and reception operations to and from the source cell continue.
S4: The UE is configured to determine whether the evaluated wait duration has passed.
S5: When the UE determines that the wait duration has passed, the UE is configured to then execute or initiate the HO. In other words, the UE initiates random access towards target cell (for example, by transmitting a PRACH request) and, if successful, stops transmission and reception to/from source cell.

It will be appreciated that, according to various arrangements and implementations, the network may control, via the configurable execution delay set or configuration by the network, whether a HO wait is implemented by a UE and, if so, with what settings.

FIG. 5 is a signalling diagram illustrating schematically a Conditional Handover scheme which includes a general implementation of an execution delay in the form of a HO execution timer in accordance with arrangements.

FIG. 5 is a signalling diagram indicating signalling steps which occur between various nodes in a standard network as part of a Handover scheme in accordance with described arrangements. Those nodes include: user equipment 110; a source node 700a and a target node 700b.

At step C1: the UE 110 is triggered to perform a measurement event.

At step C2: the measurement event triggers the UE 110 to send a measurement report.

At step C3: Based on the UE measurement report, the source node 700a is configured to take HO action.

At step C4: the source node communicates with the target nodes 700b, to prepare the target cell for the handover by sending a CHO Request.

At steps C5: the target node 700b performs admission control in relation to the HO request from the source node 700a.

At step C6: assuming the admission control at target node 700b is successful, the target node 700b informs the source node 700a that the HO request has been acknowledged.

At step C7: the source node is configured to send an RRC Reconfiguration (handover command) to the UE 110. In accordance with described arrangements, the RRC reconfiguration messaging comprises an indication (or a separate message is sent indicative) of a Handover timer configuration to be implemented by the UE 110.

At step C8: the UE continues operation, communicating with the source node 700a, whilst monitoring and evaluating radio condition and, for example other parameters, including time parameters, to determine whether a HO condition set in the RRC reconfiguration at step C7 has been met.

At step C9: if the UE 110 determines that the Handover condition has been met and, in accordance with arrangements, rather than immediately initiating a Handover Request by sending a PRACH Preamble to the target cell 700b, or immediately commencing use of preallocated resources (in the case of a RACHless handover), the UE is configured to initiate a timer in accordance with the Handover timer configuration received at step C7.

At step C10: once the handover timer has expired, the UE 110 is configured to commence full execution of the handover by ceasing transmission and reception with the source cell 700a.

At step C11: The UE 110 is configured to send a PRACH preamble to the target cell 700b.

At step C12: the target cell 700b responds to the preamble from the UE by sending a PRACH response.

At step C13: the UE indicates to the target cell 700b that RRC reconfiguration is complete.

At step C14: the target cell indicates to the source cell 700a that the handover has been a success.

At step C15: the source cell is configured to stop transmission and reception with the UE and begin data forwarding.

Having provided a general overview of an implementation in accordance with arrangements, more detail regarding configuration of a handover execution timer, or in general, how the execution delay is determined, is provided below:

### Configuration of HO Execution Timer

A HO Execution Timer in accordance with arrangements may be implemented in various ways.

According to one example implementation, a calculation of the wait time duration may be performed as follows:

In one implementation it is assumed that a network wants to distribute HO execution of a number of UE, otherwise likely to perform HO at substantially the same time, uniformly over a time remaining between a window t1 and t2. In some examples, that time window may, for example, comprise a time window between a current time and t-service, but it will be appreciated that t2 does not have to be, but can be, equivalent to t-service.

As part of messaging related to the HO execution timer, the network may provide the UE with information indicating that the last number in the UE ID is to be used as at least part of a calculation of a UE specific HO wait time duration.

For example, such a calculation may look as follows:

$$Waiting time for UE with ID yyyyyyx = x * r / 10 - t - margin$$

Where the remaining time until the end of the window in which, for example CHO is allowed to be initiated, is referred to as r. One or more other parameters, as set out above, could also be used as part of the wait time calculation, or as part of a decision as to whether a wait time is to be implemented at all. By way of example, an operational characteristic of the UE can be taken into account, for example, by applying a weight which is proportional to required QoS or reported radio conditions.

It will be appreciated that a UE-specific timer can be based upon various UE operational factors or parameters, including a dependence upon, for example, at least one of the following:
A function which depends upon a time remaining between the current time and t-Service or T2. The output of such a function can be such that it is unique for each UE, for example as set out above.
A function which depends upon a time remaining between the current time and [t-service−t-margin], where t-margin is a time margin configured by the network to allow for additional access attempts to a target cell if a first attempt fails (for instance due to a RACH collision). The network may set t-margin UE specifically depending on the UE operational characteristic, for example. Also see the above example.
A function or selection which depends upon quality of service (QOS) or priority bearers associated with a UE. For example, the wait time may be configured such that high QoS users get earlier access (or when RACH load is low) such the RACH success is likely and/or such a UE has enough time to re-attempt in case of collision. Such an example function could be based on, for example, 5G QoS identifiers. By way of example, the delay function can be determined so that the delay follows a uniform distribution between x and y, where:

For high QoS UEs: x=0 s y=1 s, and

For low QoS UEs: x=1 s y=4 s (i.e. y is larger than for the high QoS UEs).
A function or selection which depends upon a weighted distributed timer, such that the network can stagger the distribution of handover executions over time. Such an implementation may be useful in cases where, for example, interference coordination is performed in the resource domain, and appropriate adaptation(s) can be performed on the network side such that a number of resources available and number of UEs are appropriately fitted together.
A function or selection which applies a weighted distribution according to actual radio condition(s) experienced by the UE.

Each of the functions mentioned above may be defined by the network and provided to the UE, or the UE may be preconfigured with such functions to estimate the execution delay.

As said, it may be beneficial to allow some network control, supporting a distribution in which appropriate UEs have a higher likelihood of success. In an embodiment the likelihood of success of the action to be executed by the UE is based on radio condition being experienced by the UE. In an embodiment the likelihood of success of the action to be executed by the UE is based on a number of other UEs expected to perform the action to be executed by the UE. In an embodiment the likelihood of success of the action to be executed by the UE is based an indication of historic success rate of the action to be executed by the UE. In an embodiment the likelihood of success of the action to be executed by the UE is based an indication of current success rate of the action to be executed by the UE. The UE may determine any of these by itself, or the UE may receive an indication of such from the network. E.g. the network indicates the number of other UEs expected to perform the same action at a given time instant or time window.

In an embodiment the priority of the UE may be based on a quality of service associated with the UE. In an embodiment the priority of the UE may be based on priority indication from the network provided to the apparatus. In an embodiment the priority of the UE may be based on an indication of a time remaining before the action to be executed by the UE must be initiated or completed.

FIG. 6 illustrates schematically some components of a network including nodes according to some arrangements. The network 6000 comprises a plurality of network nodes 6200 which may include those in a NTN, in communication with user equipment 6100.

The user equipment 6100 takes the form of an apparatus, comprising:
6110: circuitry configured to obtain an indication of an execution delay to be applied by the apparatus in relation to an action to be executed by the apparatus, the execution delay being based upon one or more operational characteristic of the apparatus;
6120: circuitry configured to determine that the action is to be executed by the apparatus; and
6130: circuitry configured to delay execution of the action based on the execution delay.

The network access node 6200 takes the form of an apparatus, comprising:
6210: circuitry configured to determine an action to be executed by a user equipment; and
6220: circuitry configured to provide an indication of an execution delay to be applied by the user equipment in relation to the action, the execution delay being based upon one or more operational characteristic of the user equipment.

FIG. 7 illustrates schematically steps of methods performed at some network nodes in accordance with some arrangements.

The user equipment 6100 may be configured to perform a method comprising the steps of:
7110: obtaining an indication of an execution delay to be applied by the apparatus in relation to an action to be executed by the apparatus, the execution delay being based upon one or more operational characteristic of the apparatus;
7120: determining that the action is to be executed by the apparatus; and
7130: delaying execution of the action based on the execution delay.

The network access node 6200 may be configured to perform a method comprising the steps of:
7210: determining an action to be executed by a user equipment; and
7220: providing an indication of an execution delay to be applied by the user equipment in relation to the action, the execution delay being based upon one or more operational characteristic of the user equipment.

Although the arrangements and implementations have been described in relation to a RACH-based HO delay, the principles described above can be applied in relation to UE implementing RACHless handover and CHO. In particular, a handover delay may be implemented such that, for example, users with pre-allocated grant can be prioritized and UEs with pre-allocated grants which come earliest in time can be prioritized. Alternatively, in some implementations, a waiting time applied by a RACHless UE can be made dependent on the time of the pre-allocated grant.

Having described the principles of approaches and implementations in the context of implementation of HO using RACH in a NTN EFC, it will be appreciated that similar principles can be applied in relation to a backoff timer in the RACH. The Backoff timer operates to delay a UE from reattempting to connect via a RACH. If a number of UE experience RACH collision or congestion, and apply a similar RACH backoff time, then they are likely to try to reattempt a RACH request at around the same time and again experience the same congestion. Distributing such retries in time, by applying similar principles to the backoff timer, can help to mitigate such congestion. It will be appreciated that distribution in time of a RACH backoff timer may be implemented in a similar manner and the timer can be made a function of the same aspects as those described above.

Furthermore, arrangements described in relation to application of an execution delay of a handover action are applicable if an action to be executed by a UE comprises a mobility action between a source satellite and a target satellite supported by the same gNB (for example, FL switch, unchanged Physical Cell Identity (PCI) mobility).

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1.-15. (canceled)

16. A user equipment comprising:
at least one processor; and
at least one memory storing instructions that when executed by the at least one processor cause the user equipment to:
receive a configuration including conditional handover (CHO) execution conditions and a handover (HO) execution timer configuration, wherein the CHO execution conditions comprise a threshold Reference Signal Received Power (RSRP) difference at the user equipment between a source cell and target cell wherein the HO execution timer configuration comprises a network-controlled user equipment-assisted timer that has a configurable duration, wherein the duration is to depend upon parameters comprising: remaining time until t-service, required user equipment Quality of Service (QOS), user equipment priority, one or more radio condition measurement, load of a target cell, number of expected user equipments to handover based on number of user equipments in serving cell, historic of random access success rate, and current random access success rate;
obtain an indication of an execution delay to be applied by the user equipment in relation to an action comprising a HO to be executed by the user equipment, the execution delay being based upon operational characteristics of the user equipment, wherein the operational characteristic of the user equipment is based on likelihood of success of the action to be executed by the user equipment, wherein the likelihood of success of the action to be executed by the user equipment is based on the following: radio condition being experienced by the user equipment, an indication of a number of other user equipments expected to perform the action to be executed by the user equipment, an indication of historic success rate of the action to be executed by the user equipment, and an indication of current success rate of the action to be executed by the user equipment;
monitor a time based parameter related to the CHO;
upon determining that the time base parameter has been fulfilled, determine whether the CHO execution conditions have been fulfilled;
upon determining that the CHO execution conditions have been fulfilled, instead of performing the HO immediately, implement the execution delay;
during the executed delay, enable the user equipment to be configured such that transmission and reception operations to and from the source cell continue; and
after a time of the delay has past, execute the HO.

17. The user equipment according to claim 16, wherein the execution of the action is delayed until the execution delay has passed.

18. The user equipment according to claim 17, wherein the user equipment is caused to:
obtain an indication of a time restriction for performing the action to be executed by the user equipment, wherein the execution delay to be applied by the user equipment is further based on the obtained indication of time restriction.

19. The user equipment according to claim 18, wherein a greater the likelihood of success, a longer a resulting execution delay.

20. The user equipment according to claim 18, wherein a greater the likelihood of success, a smaller a resulting execution delay.

21. The user equipment according to claim 18, wherein the operational characteristics of the user equipment are further based on priority of the user equipment, and a greater the priority of the user equipment, a smaller a resulting execution delay.

22. The user equipment according to claim 21, wherein the priority of the user equipment is based on the following: an indication of quality of service associated with the user equipment, an indication of user equipment priority provided to the user equipment, and an indication of a time remaining before the action to be executed by the user equipment must be initiated or completed.

23. The user equipment according to claim 22, wherein the executed delay is further based upon a feature of a unique identifier associated with the user equipment.

24. A system comprising:
a user equipment:
at least one processor; and
at least one memory storing instructions that when executed by the at least one processor cause the user equipment to:
receive a configuration including conditional handover (CHO) execution conditions and a handover (HO) execution timer configuration, wherein the CHO execution conditions comprise a threshold Reference Signal Received Power (RSRP) difference at the user equipment between a source cell and target cell wherein the HO execution timer configuration comprises a network-controlled user equipment-assisted timer that has a configurable duration, wherein the duration is to depend upon parameters comprising: remaining time until t-service, required user equipment Quality of Service (QOS), user equipment priority, one or more radio condition measurement, load of a target cell, number of expected user equipments to handover based on number of user equipments in serving cell, historic of random access success rate, and current random access success rate;
obtain an indication of an execution delay to be applied by the user equipment in relation to an action comprising a HO to be executed by the user equipment, the execution delay being based upon operational characteristics of the user equipment, wherein the operational characteristic of the user equipment is based on likelihood of success of the action to be executed by the user equipment, wherein the likelihood of success of the action to be executed by the user equipment is based on the following: radio condition being experienced by the user equipment, an indication of a number of other user equipments expected to perform the action to be executed by the user equipment, an indication of historic success rate of the action to be executed by the user equipment, and an indication of current success rate of the action to be executed by the user equipment;
monitor a time based parameter related to the CHO;
upon determining that the time base parameter has been fulfilled, determine whether the CHO execution conditions have been fulfilled;
upon determining that the CHO execution conditions have been fulfilled, instead of performing the HO immediately, implement the execution delay;
during the executed delay, enable the user equipment to be configured such that transmission and reception operations to and from the source cell continue; and
after a time of the delay has past, execute the HO.

25. The system according to claim 24, wherein the execution of the action is delayed until the execution delay has passed.

26. The system according to claim 25, wherein the user equipment is caused to:
obtain an indication of a time restriction for performing the action to be executed by the user equipment, wherein the execution delay to be applied by the user equipment is further based on the obtained indication of time restriction.

27. The system according to claim 26, wherein a greater the likelihood of success, a longer a resulting execution delay.

28. The system according to claim 26, wherein a greater the likelihood of success, a smaller a resulting execution delay.

29. The system according to claim 26, wherein the operational characteristics of the user equipment are further based on priority of the user equipment, and a greater the priority of the user equipment, a smaller a resulting execution delay.

30. The system according to claim 29, wherein the priority of the user equipment is based on the following: an indication of quality of service associated with the user equipment, an indication of user equipment priority provided to the user equipment, and an indication of a time remaining before the action to be executed by the user equipment must be initiated or completed.

31. The system according to claim 30, wherein the executed delay is further based upon a feature of a unique identifier associated with the user equipment.

32. A method comprising:
receiving a configuration including conditional handover (CHO) execution conditions and a handover (HO) execution timer configuration, wherein the CHO execution conditions comprise a threshold Reference Signal Received Power (RSRP) difference at a user equipment between a source cell and target cell wherein the HO execution timer configuration comprises a network-controlled user equipment-assisted timer that has a configurable duration, wherein the duration is to depend upon parameters comprising: remaining time until t-service, required user equipment Quality of Service (QOS), user equipment priority, one or more radio condition measurement, load of a target cell, number of expected user equipments to handover based on number of user equipments in serving cell, historic of random access success rate, and current random access success rate;
obtaining an indication of an execution delay to be applied by the user equipment in relation to an action comprising a HO to be executed by the user equipment, the execution delay being based upon operational characteristics of the user equipment, wherein the operational characteristic of the user equipment is based on likelihood of success of the action to be executed by the user equipment, wherein the likelihood of success of the action to be executed by the user equipment is based on the following: radio condition being experienced by the user equipment, an indication of a number of other user equipments expected to perform the action to be executed by the user equipment, an indication of historic success rate of the action to be executed by the user equipment, and an indication of current success rate of the action to be executed by the user equipment;
monitoring a time based parameter related to the CHO;
upon determining that the time base parameter has been fulfilled, determining whether the CHO execution conditions have been fulfilled;
upon determining that the CHO execution conditions have been fulfilled, instead of performing the HO immediately, implementing the execution delay;
during the executed delay, enabling the user equipment to be configured such that transmission and reception operations to and from the source cell continue; and
after a time of the delay has past, executing the HO.

33. The method according to claim 32, wherein the execution of the action is delayed until the execution delay has passed.

34. The method according to claim 33, further comprising obtaining an indication of a time restriction for performing the action to be executed by the user equipment, wherein the execution delay to be applied by the user equipment is further based on the obtained indication of time restriction.

35. The method according to 34, wherein a greater the likelihood of success, a longer a resulting execution delay.
